(19) United States
(12) Patent Application Publication
(10) Pub. No.: US 2021/0061634 A1
(43) Pub. Date: Mar. 4, 2021

(54) CAN PIERCING AND STRAINING TOOL

(71) Applicant: Letitia McMichael, Bryson City, NC (US)

(72) Inventor: Letitia McMichael, Bryson City, NC (US)

(21) Appl. No.: 16/937,997

(22) Filed: Jul. 24, 2020

Related U.S. Application Data
(60) Provisional application No. 62/922,108, filed on Jul. 25, 2019.

(51) Int. Cl. B67B 7/00; B67B 7/46

(52) U.S. Cl. CPC B67B 7/24; B67B 2007/303; B67B 7/34

(57) ABSTRACT

A can piercing device that pierces openings in a can lid to allow the can to allow be used for draining or straining the can contents. The device has a pattern of punch spikes, which, when placed against a side lip of a can and rotated using an attachment hook as a fulcrum, punches a series of openings through a can lid. The series of punched openings creates a strainer to drain the liquid from the can contents before removing the can lid. Can contents can be repeatedly rinsed and drained by adding water through the openings created and draining the liquid. It is also possible to provide the can piercing device with additional features that allow the device to be used as a side cutting can opener, in order to completely remove the can lid, once the draining or straining has taken place.

### CROSS REFERENCE TO RELATED APPLICATIONS

This application claims the benefit of U.S. Provisional Application Ser. No. 62/922,108, filed Jul. 25, 2019, titled “Can Piercing and Straining Apparatus,” the entire contents of which are hereby incorporated by reference.

### FIELD OF THE DISCLOSURE

Embodiments provide a can piercing tool that pierces openings in a can lid to allow the can to allow be used for draining or straining the can contents. The device has a pattern of punch spikes, which, when placed against a side lip of a can and rotated using an attachment hook as a fulcrum, punches a series of openings through a can lid. The series of punched openings creates a strainer to drain the liquid from the can contents before removing the can lid. Can contents can be repeatedly rinsed and drained by adding water through the openings created and draining the liquid. It is also possible to provide the can piercing device with additional features that allow the device to be used as a side cutting can opener, in order to completely remove the can lid, once the draining or straining has taken place.

### BACKGROUND

Traditionally, separating solid and liquid contents from an opened tin can is tedious and can be dangerous. One commonly-used method of separating solid and liquid contents from an opened can is by pushing the cut lid into the can, forcing the contents to remain in the can while the liquid drains. Once draining is complete, the operator can remove the sharp inverted can lid by using a fork or other tool, which can result in injuries to fingers or thumbs. Another downside to this method is that the can lid should be rinsed and cleaned prior to the opening step, otherwise, dirt or debris from the can lid can contact the food items within the can when the lid is pressed inward.

A second method separating solid and liquid contents from an opened tin can includes using a colander as a straining device. This two-step process requires the user to first open the can, and to then pour the can contents into a colander for rinsing. This method requires the user to own multiple kitchen items, as well as requires subsequent cleaning of the colander after use. Improvements to can piercing and straining are thus desirable.

### BRIEF SUMMARY

Embodiments described herein thus provide a can piercing device that pierces openings in a can lid to allow the can to allow be used for draining or straining the can contents. The device has a pattern of punch spikes that punch a series of openings through a can lid. The series of punched openings creates a strainer to drain the liquid from the can contents before removing the can lid. It is also possible to provide the can piercing device with additional features that allow the device to be used as a side cutting can opener, in order to completely remove the can lid, once the draining or straining has taken place.

In one example, there is provided a can piercing tool, comprising an elongated body; an attachment hook for attachment to a can lid perimeter; and a plurality of punch spikes position distal to the attachment hook for punching a plurality of holes into a can lid during a single punch event. The attachment hook and the plurality of punch spikes may be mounted on a plate that is secured to an end of the elongated body. In one embodiment, the elongated body has an end comprising a curved face. The plurality of punch spikes may be provided in more than one row. The spikes may also have differing lengths and/or triangular cross-sections. It is possible for the spikes to have spike tips with longitudinal axes that form differing angles with respect to an end of the elongated body. The can piercing tool described may be incorporated into a handheld can opener device.

### BRIEF DESCRIPTION OF THE DRAWINGS

FIG. 1 shows a side perspective view of one embodiment of a can piercing tool described herein.

FIG. 2 shows a front perspective view of the end of the can piercing tool of FIG. 1.

FIGS. 3A-3D show various embodiments of can piercing tools having varied punch spike shapes and configurations.

FIG. 4 shows a side perspective view of one embodiment of a can piercing tool having three punch spikes in a triangular pattern.

FIG. 5 shows a side plan view of the can piercing tool of FIG. 4.

FIG. 6 shows a top plan view of the can piercing tool of FIG. 4.

FIG. 7 shows a side perspective view of a handheld can opener with a can piercing tool incorporated therein.

FIG. 8 shows side perspective views of various grip options for a can opener device.

FIG. 9 shows a top plan view of one option of a can opener with a can piercing tool incorporated therein.

FIG. 10 shows a side plan view of the can opener of FIG. 9.

FIGS. 11A-11F shows sketches of various options of can opener devices.

FIGS. 12A and 12B show one option for incorporating a can piercing tool into a can opener device.

FIG. 13 shows a cross sectional view of a can piercing tool with separately formed attachment hook and spikes that are independently set into the elongated handle.

### DETAILED DESCRIPTION

There thus exists a need for a system that allows a user to strain directly from a can. This disclosure solves the above-described problems of straining by transforming the can lid into a strainer by way of a pattern of punched holes. Unlike traditional church-key-style can punching devices, which are only capable of punching one larger hole, the device of this disclosure allows multiple smaller holes to be punched in the can lid in one movement. Punching smaller holes (rather than punching a plurality of larger holes around the can lid perimeter using a church-key-style device) allows liquid to be strained from the can without solid contents escaping. Additionally, multiple holes allow more flow. Being able to create multiple holes with a single wrist stroke or punch saves time and adds to user efficiency and pleasure. None of the various types of can piercing devices available have the ability to punch multiple holes simultaneously in the top of a can lid, nor do they create a pattern of holes that allows a user to efficiently drain liquid from the solid contents of the can, prior to removing the can lid itself.

The disclosed can piercing tool can also optionally be manufactured into an existing can opener. For ease of discussion, the can piercing tool 10 will first be described on its own. It should be understood that the can piercing tool 10 may be manufactured and sold on its own, in the described form. In alternate embodiments, the can piercing tool 10 may be incorporated into a handheld can opener device 40, described further below.

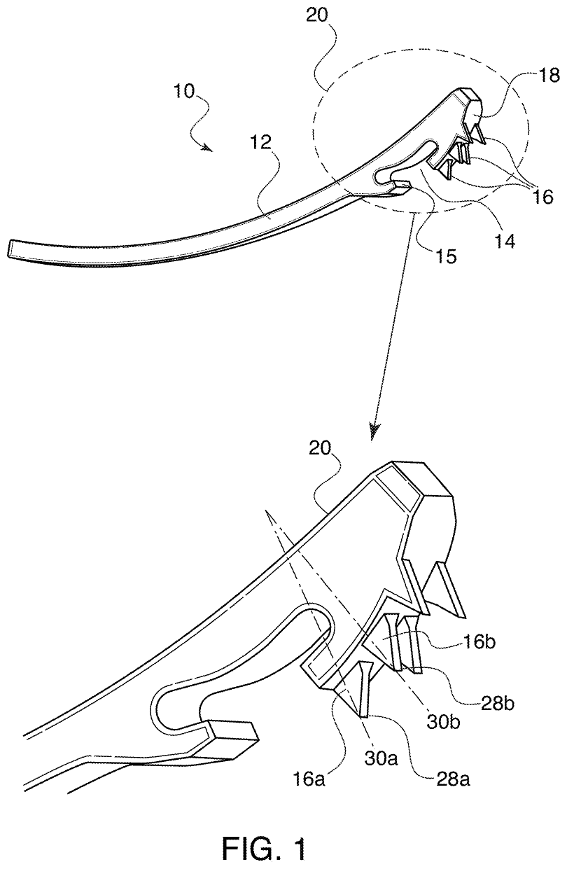

Referring now to FIG. 1, there is shown one embodiment of a can piercing tool 10. The can piercing 10 has an elongated body 12 that may function as a handle. In alternate embodiments, the elongated body 12 may be incorporated into a can opener device body. In one example, the elongated body 12 may be curved. One end 20 of the elongated body 12 is shown having an attachment hook 14. Attachment hook 14 is used to engage a lip around the perimeter of a can in use. It may have a traditional grasping lip 15 that secures to the can lip edge.

Extending distally from the attachment hook 14 is a plurality of punch spikes 16. It has been found that providing a plurality of punch spikes 16 (rather than the single punch head of a church-style-key) allows the user to punch a plurality of openings in the can lid with a single wrist movement. Providing this plurality of punch spikes 16 also allows the draining or straining of the can to occur quickly, with one or more of the openings available for liquid draining and one or more of the openings available for venting of air.

The end 20 of the elongated 12 may have a curved face 18. Curved face 18 allows the user to “roll” the punch spikes 16 into the can using the attachment hook 14 as a fulcrum or pivot point. Curved face 18 causes a first row 22 of one or more punch spikes 16a nearest the attachment hook 14 to puncture the can lid first. Continued movement of the user's wrist causes a second row 24 of one or more punch spikes 16b (positioned distal to the punch spike(s) 16a) to puncture the can lid next. If a third (or any subsequent) row 26 of punch spikes is provided, curved face 18 allows the third row 26 (or any subsequent row) of punch spikes 16c, to puncture the can lid next (or last).

In addition to or instead of curved face 18, it is possible to provide the plurality of punch spikes 16 as having different lengths or different angles or both. This may be particularly useful if the end 20 of the elongated body 12 is a flat surface. For example, the rows that are more distal from the attachment hook 14 (the second or third rows 24, 26) may have longer punch spikes 16 than those of the first row 22. This can allow the longer spikes to puncture the can more effectively, even if the face is not curved (e.g., flat face) or has only a slight curve.

Additionally or alternatively, the punch spikes 16 may have different angles with respect to the end 20. For example, assuming that the end 20 is a flat surface (which, as described above, may not be a flat surface but a curved face 18), one or more punch spikes 16a may have a spike tip 28a with an axis 30a that makes an acute angle with end 20 surface. One or more of the punch spikes 16b may have a spike tip 28b with an axis 30b that is perpendicular to the end 20 surface. It is also possible for one or more punch spikes to have a spike tip with an axis that makes an obtuse angle with the end 20 surface. The angles and lengths may be optimized and varied to prevent all punch spikes 16 from contacting the can lid at the same time. It has been found that without providing a curved face 18 or varying the lengths and/or angles (e.g., if all of the punch spikes 16 contact the can lid at the same time), too much pressure is required of the user in order to puncture holes.

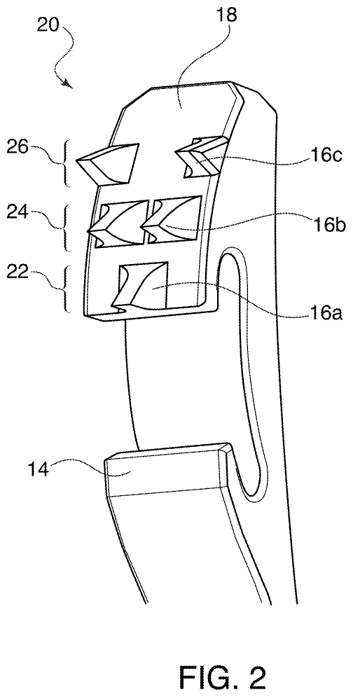

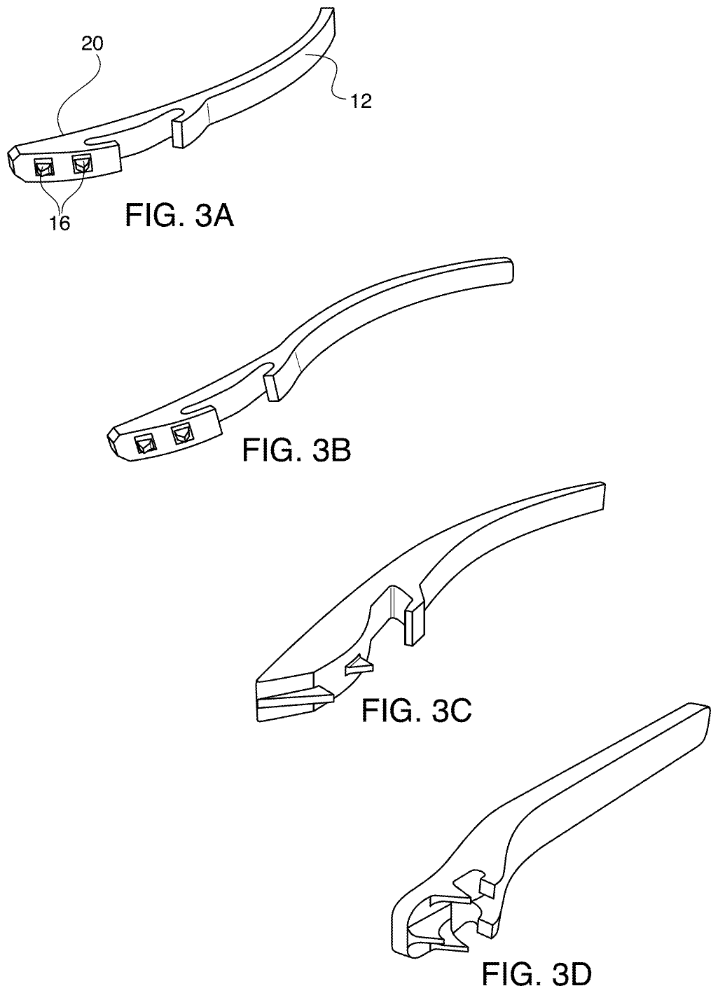

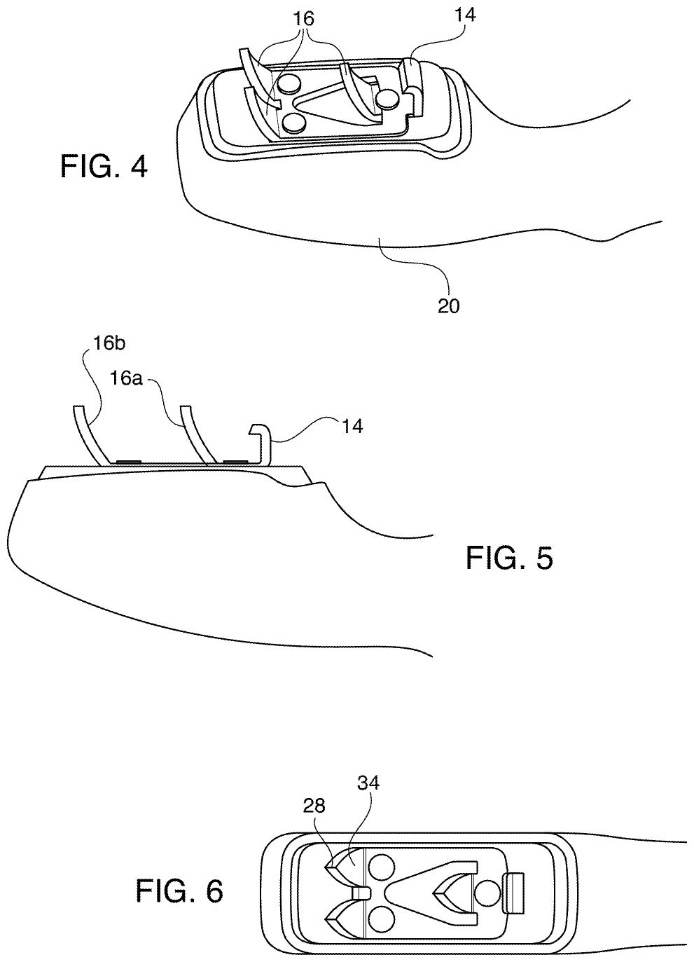

In a specific embodiment, five punch spikes 16 may be provided at the end 20 of the elongated body 12. This embodiment is illustrated by FIGS. 1-2. In this embodiment, there is a first punch spike 16a in first row 22, two punch spikes 16b and second row 24, and two punch spikes 16c in third row 26. As shown, the spacing between the punch spikes may be varied. In an alternate embodiment, two punch spikes 16 may be provided at the end 20 of the elongated body 12. This embodiment is illustrated by FIGS. 3A-3D. In these alternate embodiments, the punch spikes may be side-to-side or in first and second rows. In a further embodiment, three punch spikes 16 may be provided at the end 20 of the elongated body 12. This embodiment is illustrated by FIGS. 4-6. In this embodiment, a first punch spike 16a is provided in first row 22, and two punch spikes 16b are provided in second row 24. The punch spikes 16 in this embodiment are provided as three punch spikes 16 in a triangle pattern. As shown by the side plan view of FIG. 5, the end 20 may be a flat face, and the punch spikes 16a, 16b may themselves be curved. As illustrated by these options, the number of punch spikes 16 may be varied. The placement of the punch spikes 16 may be varied. The curvature or angle of the punch spikes 16 may be varied.

The punch spikes 16 may be formed integrally with the elongated body 12. The attachment hook 14 may be formed integrally with the elongated body 12. Alternatively, the punch spikes 16 may be manufactured separately and installed into the elongated body 12. The attachment hook 14 may be manufactured separately and installed onto the elongated body 12. Each punch spike 16 and/or the attachment hook 14 may be screwed, welded, adhered by an adhesive, or secured by any other appropriate attachment method into or to the end of elongated body 12. In one example, the attachment hook 14 is sonic welded to the elongated body 12 and the punch spikes are mounted to a plate 32 that is separately screwed onto or otherwise attached to the end 20 of the elongated body 12. In a further example, the attachment hook 14 and the punch spikes are all mounted to a plate 32 that is screwed onto or otherwise attached to the end 20 of the elongated body 12.

The elongated body 12 may be made of metal, such as stainless-steel. The punch spikes 16 and/or attachment hook 14 are also made of metal or other similar material. In an alternate embodiment, the elongated body 12 and/or the punch spikes 16 and/or the attachment hook 14 may be made of high density plastic. It is also possible for a combination of materials to be used. For example, the elongated body 12 may be plastic and the punch spikes 16 and/or attachment hook 14 may be metal, or vice versa, or any combination thereof.

It is generally envisioned that each punch spike 16 has a generally triangular perimeter, such that the base 34 of each punch spike 16 provides a base support, and a spike tip 28 provides the initial hole creation or punching function. The punch spikes 16 may have a pyramid or cone-shaped cross-section, as shown by FIG. 2. The punch spikes 16 may have a flat cross-section from the side, as shown by FIG. 5.

Functionality occurs when the attachment hook 14 is positioned against the side rim of a can as a fulcrum element and subsequent rotation of the elongated body 12 causes the punch spikes to engage and punch through the can lid, creating multiple openings in the can lid, one opening for each punch spike 16. The punch spikes 16 receive downward pressure in order to punch through the can lid while the grasping lip 15 of the attachment hook 14 creates a fulcrum point that receives upward pressure. The rolling movement of the elongated body 12 causes a sequential punching process, such that the first row 22 of punch spikes 16 engage the can lid first, with later rows 24, 26 (if provided) engaging the can lid subsequently. The end result is that the can lid has a plurality of openings created by the plurality of punch spikes 16, allowing the can lid to function as a strainer.

The punch spikes 16 are generally sized in order to create an opening that is small enough to allow a user to drain a can of canned peas or canned corn or other smaller food item, so that liquid from the can exits from the opening, but not the food items. Because the openings created are generally smaller than those created with a church-key-style can punch (and also provided as more than one opening), the disclosed canned piercing tool 10 allows use with various types of food item cans. In a specific embodiment, the punch spikes are sized to create about ⅜″ diameter openings in the can lid. The series of punched openings creates a method of draining liquid directly from the can lid prior to cutting the lid from the can.

The can piercing tool 10 may be manufactured for independent use. In this version, once the food items within the can have been drained/strained, the can lid may be removed using a separate kitchen device, such as a traditional handheld or electric can opener. However, it is also possible for the can piercing tool 10 to be machined, manufactured, or otherwise integrated into a handheld can opener during manufacturing. This embodiment allows the user to remove the can lid after draining/straining has taken place, using a single device. While handheld can openers are the standard for removing can lids, none currently possess the ability to punch holes in the lid prior to cutting, turning the lid into a straining device.

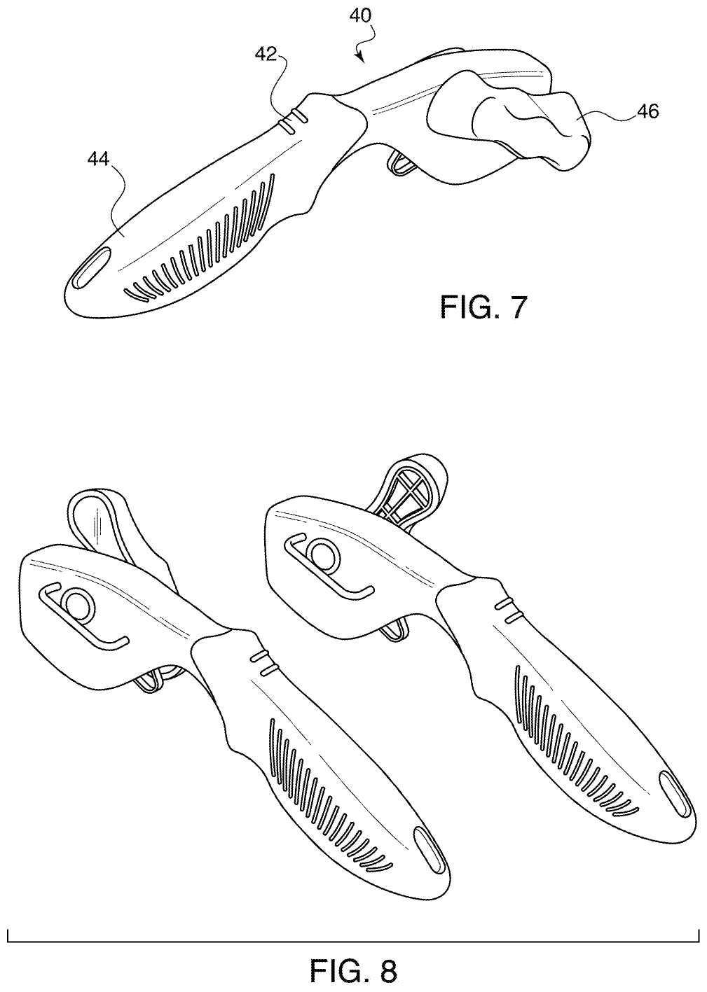

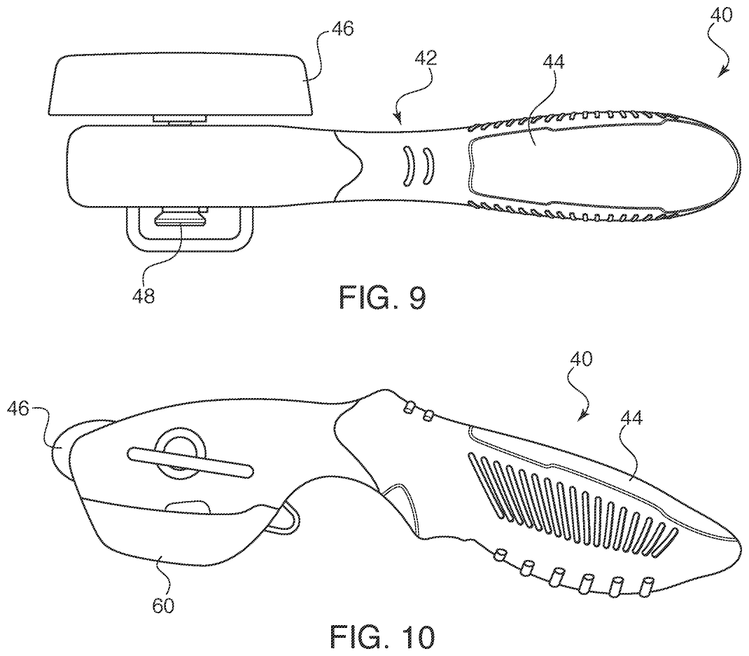

Accordingly, as illustrated by FIGS. 7-12, the disclosed can piercing tool 10 can be incorporated into a handheld can opener 40 in order to enhance the functionality of the opener 40. The can piercing tool 10 can designed into a handheld can opener 40 as one complete piece at the time of manufacturing. In this version, the can piercing tool 10 can be provided with threaded holes for attachment to a can opener housing 42. This attachment may be via attachment screws, welding, adhesive, or any other appropriate attachment method.

As shown by FIGS. 7-10, the can opener device housing 40 may be formed with a handle 44 (in which the elongated body 12 is housed). A cap 60 may be provided to cover the attachment hook 14 and spikes 16. This may be for safety or for aesthetics.

Once the straining has taken place, twisting movement of the grip 46 causes rotation of a cutting wheel 48 to remove the can lid.

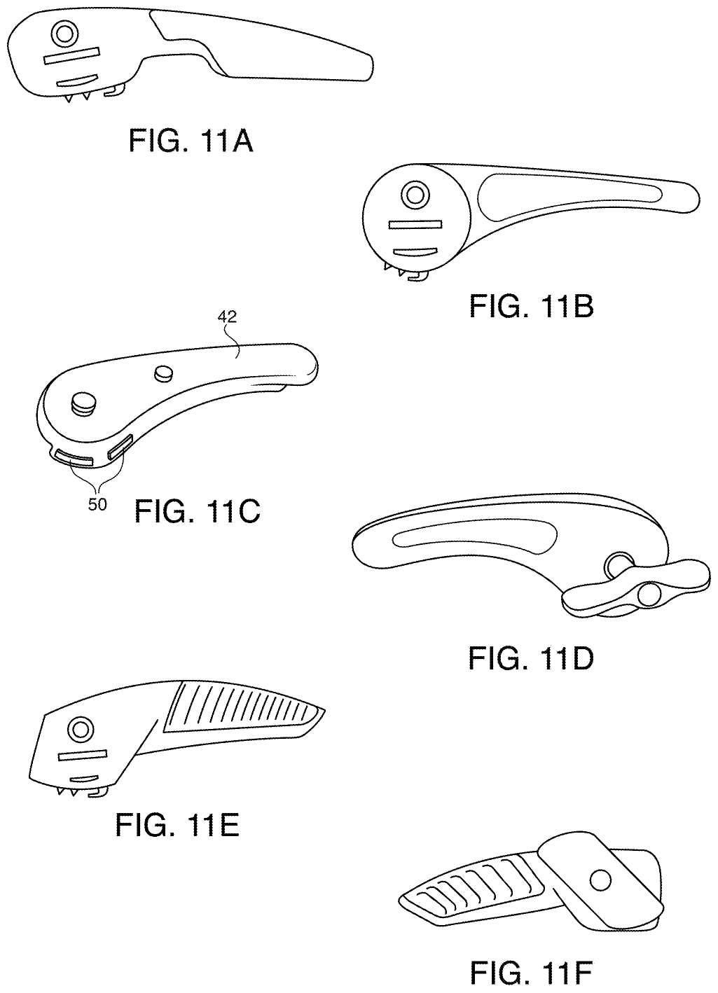

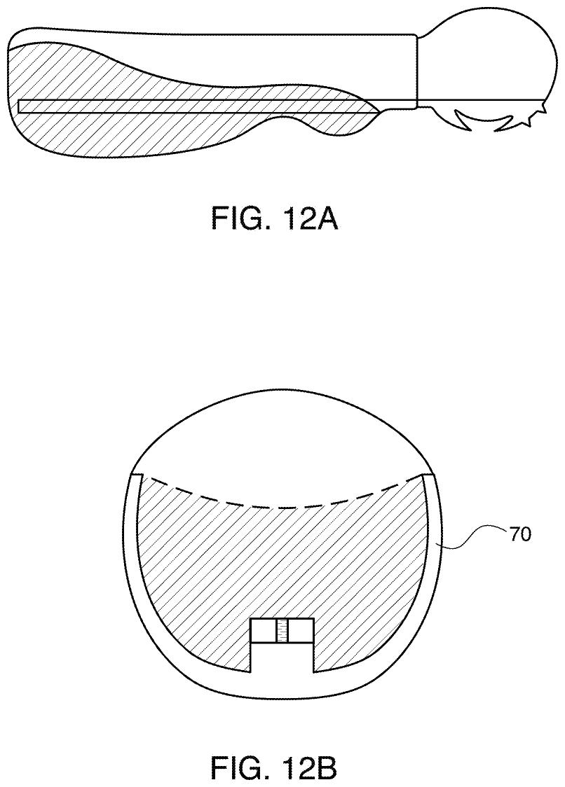

As shown by FIG. 11 (and specifically, FIG. 11C), one embodiment may have an over mold housing 42 with one or more openings 50 through which the punch spikes 16 may extend in use.

As shown by FIGS. 12A and 12B, it is possible for the can piercing tool 10 to be embedded within a silicone grip 70 or other type of housing that allows ease of use. The elongated body may be embedded in the silicone. One of ordinary skill in the art would understand that there are a number of ways to incorporate canned piercing tool 10 into a handheld can opener device 40.

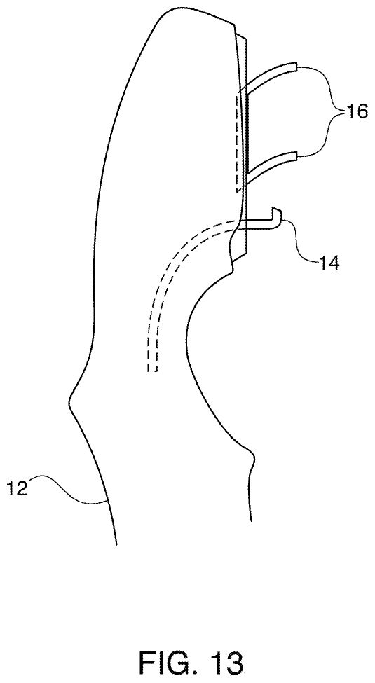

FIG. 13 shows that the attachment hook and the spikes may be manufactured separately and embedded into an elongated body 12.

Changes and modifications, additions and deletions may be made to the structures and methods recited above and shown in the drawings without departing from the scope or spirit of the disclosure or the following claims.

What is claimed is:

1. A can piercing tool, comprising:
(a) an elongated body;
(b) an attachment hook for attachment to a can lid perimeter;
(c) a plurality of punch spikes position distal to the attachment hook for punching a plurality of holes into a can lid during a single punch event.

2. The can piercing tool of claim 1, wherein the attachment hook and the plurality of punch spikes are mounted on a plate that is secured to an end of the elongated body.

3. The can piercing tool of claim 1, wherein the elongated body has an end comprising a curved face.

4. The can piercing tool of claim 1, wherein the plurality of punch spikes are provided in more than one row.

5. The can piercing tool of claim 1, wherein the plurality of punch spikes have differing lengths.

6. The can piercing tool of claim 1, wherein the plurality of punch spikes have spike tips with longitudinal axes that form differing angles with respect to an end of the elongated body.

7. The can piercing tool of claim 1, wherein the plurality of punch spikes have triangular cross-sections.

8. The can piercing tool of claim 1, incorporated into a handheld can opener device.
